(19) United States
(12) Patent Application Publication
(10) Pub. No.: US 2026/0352348 A1
(43) Pub. Date: Nov. 5, 2026

(54) ASYMMETRIC COMMUNICATION LINK TRAINING

(71) Applicant: Infineon Technologies Americas Corp., El Segundo, CA (US)

(72) Inventors: Seid Alireza Razavi Majomard, Belmont, CA (US); Ragnar Jonsson, Aliso Viejo, CA (US); Peter Van Dyck, Sunnyvale, CA (US)

(73) Assignee: Infineon Technologies Americas Corp., El Segundo, CA (US)

(21) Appl. No.: 19/664,614

(22) Filed: Apr. 30, 2026

Related U.S. Application Data
(60) Provisional application No. 63/797,760, filed on Apr. 30, 2025.
(60) Provisional application No. 63/805,184, filed on May 13, 2025.

(51) Int. Cl. H04B 17/00; H04B 17/20; H04B 17/29

(52) U.S. Cl. CPC H04B 17/0085; H04B 17/255; H04B 17/295

(57) ABSTRACT

The present disclosure relates to training and transitioning an asymmetric communication link. A method includes transmitting, by a first physical layer device, a training frame on a low data rate direction of an asymmetric communication link having a high data rate direction. The training frame comprises altered bits grouped at one or more frame boundaries, positioned to maximize a length of a continuous sequence of unaltered bits, with the unaltered bits forming the continuous sequence extending contiguously across a remainder of the training frame. The method includes receiving, over the high data rate direction, a remote receiver status indication from a second physical layer device, and transitioning the low data rate direction directly from a training state to a data transmission state in response to the remote receiver status indication indicating satisfactory receiver status at the second physical layer device. Apparatuses are also provided.

### CROSS-REFERENCE TO RELATED APPLICATIONS

This application claims priority to U.S. Provisional Application No. 63/797,760, titled “Asymmetric Training Time for Asymmetric Camera Link” and filed Apr. 30, 2025, which is hereby incorporated by reference in its entirety. This application also claims priority to U.S. Provisional Application No. 63/805,184, titled “Training Frame with Continuous Unaltered Bits for Link Synchronization and Training” and filed May 13, 2025, which is hereby incorporated by reference in its entirety.

### FIELD OF INVENTION

The present disclosure relates to physical layer devices for asymmetric communication links, and more particularly to training frame structures and state machine configurations that enable independent transition to data transmission based on remote receiver status in bidirectional communication systems having different data rates in each direction.

### BACKGROUND

Communication systems employ physical layer (PHY) devices to connect sensors, cameras, and other components to processing units. For example, automotive communication systems may connect cameras and sensors to electronic control units and switches. These communication links may operate asymmetrically, with different data rates in each direction to accommodate the varying bandwidth requirements of different data types. A link may carry high-bandwidth video data in one direction while carrying lower-bandwidth control and configuration data in the opposite direction.

Physical layer devices undergo a training sequence during link startup to enable receivers to acquire timing, equalize the channel, and establish reliable communication. During training, physical layer devices exchange training frames containing status information that coordinates the transition from training to data transmission. Some training sequences may require both directions of a bidirectional link to complete training before either direction can begin data transmission. Additionally, some training frame structures may distribute varying content throughout the frame in a manner that increases complexity for receiver adaptation.

### BRIEF DESCRIPTION OF THE DRAWINGS

Non-limiting and non-exhaustive examples are described with reference to the following figures.

FIG. 1A illustrates a block diagram of an asymmetric communication link connecting physical layer devices, according to aspects of the present disclosure.

FIG. 1B illustrates a detailed block diagram of a first transmitter of a first physical layer device, according to aspects of the present disclosure.

FIG. 2 illustrates a block diagram of an asymmetric communication system with physical layer devices, according to aspects of the present disclosure.

FIG. 3A illustrates a flowchart for a method for training and transitioning an asymmetric communication link, according to aspects of the present disclosure.

FIG. 3B illustrates a flowchart for the method of FIG. 3A with optional steps including asymmetric transition, configuration data transmission, and acknowledgment indication, according to aspects of the present disclosure.

FIG. 4 illustrates a frame structure comparison between a training frame and an encoded frame, according to aspects of the present disclosure.

FIG. 5 illustrates an alternative training frame structure for a low data rate direction, according to aspects of the present disclosure.

FIG. 6 illustrates a modified information field view showing an internal structure of a modified information field, according to aspects of the present disclosure.

FIG. 7 illustrates a block diagram of an encoder system configured to produce zero-filled encoded blocks during training, according to aspects of the present disclosure.

FIG. 8 illustrates a block diagram of an encoder system with multiplexer-based selection, according to aspects of the present disclosure.

FIG. 9 illustrates a state diagram for a PHY control state machine for a low data rate direction, according to aspects of the present disclosure.

FIG. 10 illustrates a synchronous transition timing diagram for an asymmetric communication link, according to aspects of the present disclosure.

FIG. 11 illustrates an asynchronous transition timing diagram for an asymmetric communication link, according to aspects of the present disclosure.

### DETAILED DESCRIPTION

Communication links connect devices such as cameras and sensors to processing units. Before these devices can exchange data, they are configured to coordinate a startup process that includes training to ensure both sides are ready. In asymmetric communication links, where data flows faster in one direction than the other, this training process presents particular challenges and opportunities. The present disclosure provides methods and apparatuses for training asymmetric communication links that enable the slower direction to complete training and begin data transmission independently of the faster direction.

In one aspect, a method includes transmitting, by a first physical layer device, a training frame on a low data rate direction of an asymmetric communication link that further has a high data rate direction. The training frame comprises altered bits grouped together at one or more frame boundaries with the altered bits being positioned to maximize a length of a continuous sequence formed by unaltered bits, and the unaltered bits forming the continuous sequence that extends contiguously across a remainder of the training frame. The method further includes receiving, by the first physical layer device and over the high data rate direction, a remote receiver status indication from a second physical layer device, and transitioning, by the first physical layer device, the low data rate direction directly from a training state to a data transmission state in response to the remote receiver status indication indicating satisfactory receiver status at the second physical layer device.

In another aspect, an apparatus comprises a receiver configured to receive, from a remote physical layer device, a training frame on a low data rate direction of an asymmetric communication link, and a transmitter configured to transmit, over a high data rate direction, a remote receiver status indication to the remote physical layer device. The apparatus may further comprise a controller configured to extract timing information from a continuous sequence of unaltered bits within the training frame to facilitate timing recovery.

In the context of asymmetric communication links, physical layer devices (devices that transmit and receive signals over a physical communication medium) undergo a training sequence during link startup to enable receivers to acquire timing, equalize the channel, and establish reliable communication. During training, physical layer devices exchange training frames containing status information that coordinates the transition from training to data transmission. In some systems, the transition from a training state to a countdown state may require that both the local receiver status and the remote receiver status indicate satisfactory operation. Both link partners may confirm that their respective receivers are operating reliably before either side can advance to the countdown state. The countdown state may serve as a synchronization mechanism that coordinates the simultaneous transition of both link partners from training to data transmission.

In one approach, a symmetric transition may be enforced where both directions of the link enter data mode at substantially the same time. In an asymmetric link configuration where one direction operates at a lower data rate and the other direction operates at a higher data rate, the lower data rate receiver may lock onto the training signal and complete receiver adaptation faster than the higher data rate receiver. Under such an approach, the lower data rate direction may not transition to data mode until the higher data rate direction also reports satisfactory receiver status. Both sides may remain in the training state until the slower receiver completes its adaptation, delaying the availability of the lower data rate link for transmitting configuration or initialization data.

Additionally, some training frame structures may distribute altered bits (bits that differ from a baseline pattern, such as information field content and forward error correction (FEC) parity) among unaltered training bits (bits that maintain a consistent pattern, such as zero-filled sequences) throughout the frame. This distribution of altered bits across the frame can interrupt the continuous sequence of unaltered bits available for receiver adaptation, reducing the effective length of uninterrupted zero sequences that the receiver can use for pseudo-random binary sequence locking and timing recovery. Some training frames may maintain a full information field structure including partial frame count fields and checksum fields in both directions of the link, even in the lower data rate direction where countdown state coordination and associated partial frame count may not be utilized.

In accordance with the present disclosure, a training frame structure groups altered bits together at one or more frame boundaries, positioning the altered bits to maximize a length of a continuous sequence formed by unaltered bits. The disclosed embodiments position altered bits, such as information field content and forward error correction parity, adjacent to each other, enabling the unaltered bits to form a continuous sequence that extends contiguously across a remainder of the training frame. This extended continuous sequence of unaltered bits facilitates pseudo-random binary sequence locking and timing recovery by providing a longer uninterrupted pattern for receiver synchronization.

Additionally, in some embodiments of the present disclosure, the low data rate direction transitions directly from a training state to a data transmission state in response to a remote receiver status indication indicating satisfactory receiver status at the second physical layer device, independent of a local receiver status of the first physical layer device. In some embodiments, a countdown state is omitted from a state machine controlling transmissions on the low data rate direction where a common modulation is employed for both training and data transmission. This simplified state machine enables the low data rate direction to transition to the data transmission state prior to the high data rate direction completing its training sequence, permitting transmission of configuration data while the high data rate direction continues training. The disclosed embodiments also eliminate fields rendered unused by the omission of the countdown state, such as partial frame count fields, while retaining a start of frame delimiter that identifies the training frame.

There are several technical advantages of the asymmetric communication link training of the present disclosure. First, the training frame structure that groups altered bits together at one or more frame boundaries and positions the altered bits to maximize a length of a continuous sequence formed by unaltered bits facilitates pseudo-random binary sequence locking and timing recovery by providing a longer uninterrupted pattern for receiver synchronization. This extended continuous sequence of unaltered bits enables the receiver to acquire timing and synchronize to the transmitted signal more efficiently than training frame structures that distribute altered bits throughout the frame.

Second, the independent transition to data transmission based on remote receiver status enables the low data rate direction to complete training and begin data transmission prior to the high data rate direction completing its training sequence. This asymmetric training completion permits transmission of configuration data over the low data rate direction while the high data rate direction continues training, reducing the overall time to establish a fully operational communication link. In applications such as automotive camera links, this enables camera sensor initialization to proceed while the high data rate direction continues training, reducing camera link readiness time.

Third, the simplified state machine for the low data rate direction reduces implementation complexity by omitting states that are rendered not utilized when a common modulation is employed for both training and data transmission. The elimination of the countdown state, transmit switch state, and test state from the state machine controlling transmissions on the low data rate direction reduces the number of states from seven to four, simplifying the control logic while maintaining full functionality for the low data rate direction.

Fourth, the modified information field that eliminates fields rendered not utilized by the omission of the countdown state increases the length of the unaltered bit sequence within the training frame. By eliminating partial frame count fields and other octets that are not utilized in the low data rate direction, the training frame provides an extended continuous sequence of unaltered bits that further facilitates receiver synchronization.

Fifth, the training frame structure that mirrors the data frame structure enables the same hardware to be used for data mode, training, and link synchronization. This design reduces implementation complexity for the receiver, which can process both training frames and data frames using common circuitry.

Sixth, in configurations where clock offset may be present, the continuous signal transmission during link synchronization enables the receiving side to recover the clock from the transmitted signal more rapidly. The extended continuous sequence of unaltered bits within the training frame supports faster clock recovery by providing a consistent pattern for timing acquisition.

These technical advantages collectively contribute to an asymmetric communication link training approach that reduces link establishment time, simplifies implementation, and enhances receiver synchronization performance.

The following paragraphs provide definitions of terms used throughout this disclosure.

As used herein, the term “physical layer device” refers to any device, component, or circuitry that implements physical layer functionality for a communication link, including but not limited to transceivers, transmitters, receivers, controllers, and combinations thereof that interface with a communication medium to transmit or receive signals. A physical layer device may include a transmitter, which refers to any device, circuit, or component configured to transmit signals over a communication medium, including but not limited to modulators, drivers, and signal conditioning circuitry. A physical layer device may also include a receiver, which refers to any device, circuit, or component configured to receive signals from a communication medium, including but not limited to demodulators, amplifiers, equalizers, and signal processing circuitry. A physical layer device may further include a controller, which refers to any processing element, logic circuit, state machine, or combination thereof that manages operations, coordinates activities, controls state transitions, or extracts timing information from received signals within the physical layer device.

As used herein, the term “asymmetric communication link” refers to a bidirectional communication link that supports different data rates, modulation schemes, or other transmission characteristics in each direction of communication. During link startup, physical layer devices exchange training frames, which refer to frame structures transmitted during a training sequence to enable receiver adaptation, timing acquisition, channel equalization, or coordination of state transitions between physical layer devices. A training frame includes a frame boundary, which refers to a position at or near the beginning or end of a frame structure where frame elements may be positioned. A training frame may also include an information field, which refers to a portion of a frame structure that carries control information, status information, capability information, or other non-payload data used for link management and coordination between physical layer devices. A start of frame delimiter refers to a pattern, value, or marker within a frame structure that identifies the beginning of a frame or distinguishes one frame type from another.

Within a training frame, altered bits refer to bits that differ from a baseline pattern, including but not limited to information field content, forward error correction parity bits, status bits, and other frame elements that vary from an unaltered reference pattern such as a zero-filled sequence. Unaltered bits refer to bits within a training frame that maintain a consistent pattern, such as zero-filled sequences, that facilitate receiver synchronization, pseudo-random binary sequence locking, or timing recovery. Zero-filled encoded blocks refer to encoded data blocks, such as 64B/65B encoded blocks, that contain a zero pattern or are produced when an encoder operates in a mode that generates zero-filled output. Zero-filled encoded blocks are distinct from encoded blocks with all-zero payload data, which refer to encoded data blocks produced during normal data transmission when the payload data happens to contain all zeros; a distinguishing characteristic such as an information field signature enables a receiving device to differentiate between training frames containing zero-filled encoded blocks and data frames containing encoded blocks with all-zero payload data. Timing recovery refers to the process by which a receiving device extracts timing information from a received signal to synchronize local sampling or processing with the timing of the transmitted signal.

Physical layer devices operate according to a state machine, which refers to any logic, circuitry, or control mechanism that governs transitions between operational states of a physical layer device, including but not limited to hardware state machines, software-implemented state machines, and firmware-based control logic. A state machine may control transmissions on a direction of a communication link by governing when and how signals are transmitted in that direction. A training state refers to a state of a physical layer device or state machine during which training frames are transmitted to enable receiver adaptation and link establishment. A data transmission state refers to a state of a physical layer device or state machine during which data frames carrying payload information are transmitted over the communication link. A countdown state refers to a state in a physical layer control state machine that coordinates timing for transitions between different transmission modes, such as transitions involving modulation changes. Common modulation refers to the use of a same or substantially similar modulation scheme for both training and data transmission in a given direction of a communication link.

During training, physical layer devices exchange status information. A remote receiver status indication refers to any signal, status bit, or information communicated from a remote physical layer device that indicates the operational status, readiness, or condition of a receiver at the remote device. A remote receiver status indication may indicate satisfactory receiver status when the receiver at the remote device has achieved a level of operation sufficient for reliable communication. A local receiver status refers to the operational status, readiness, or condition of a receiver within a physical layer device, as determined by that device. An encoder refers to any device, circuit, or logic that transforms input data into an encoded format, including but not limited to block encoders, line encoders, and forward error correction encoders. Forward error correction refers to any error correction coding technique that adds redundant information to transmitted data to enable detection and correction of errors at a receiver without depending on retransmission, including but not limited to Reed-Solomon coding and other block or convolutional coding schemes.

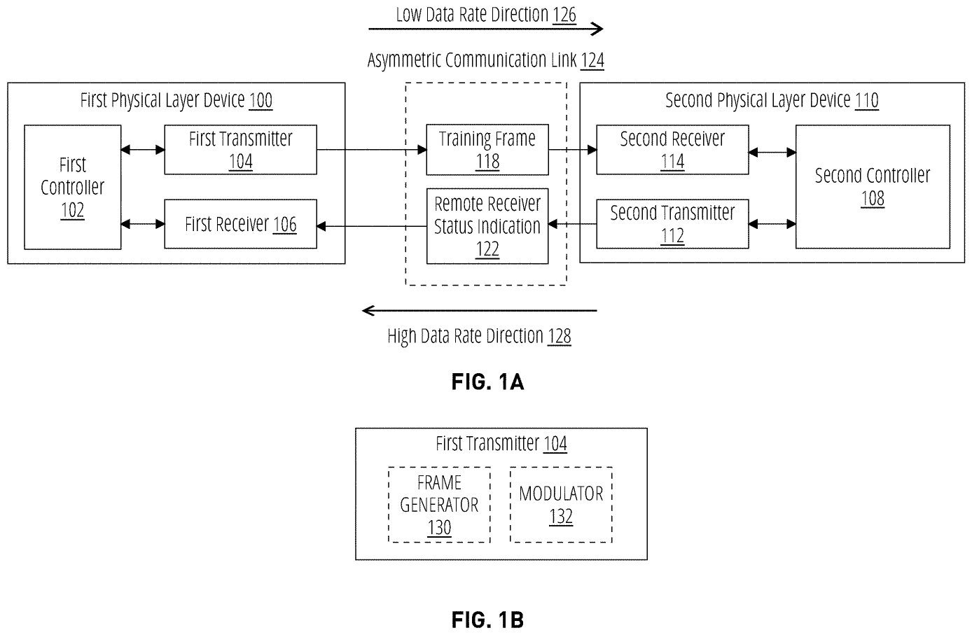

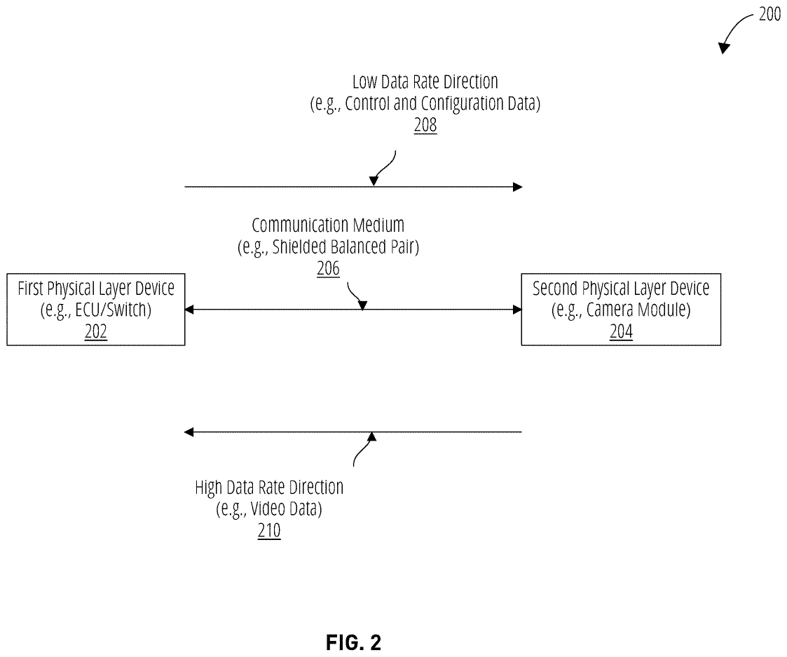

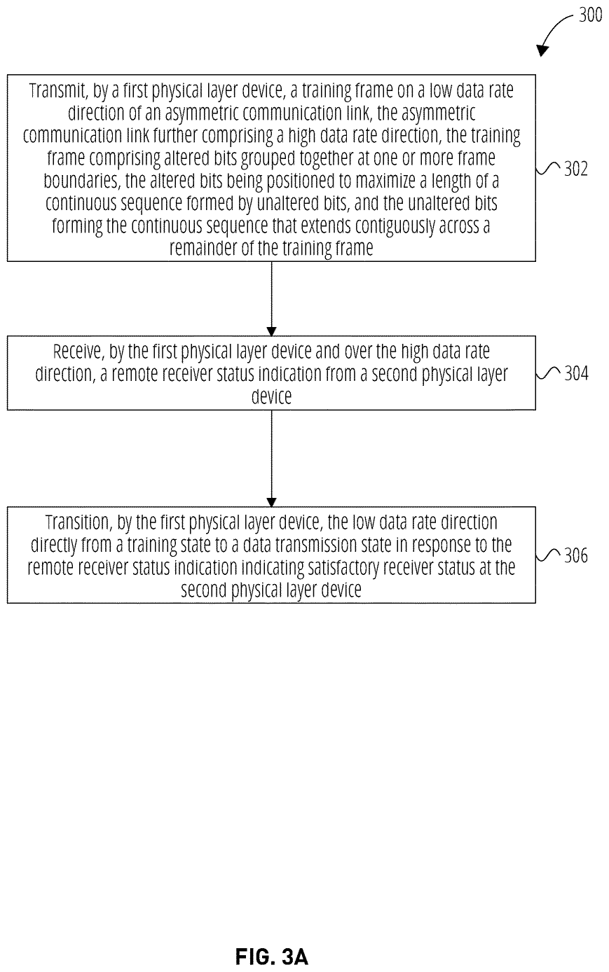

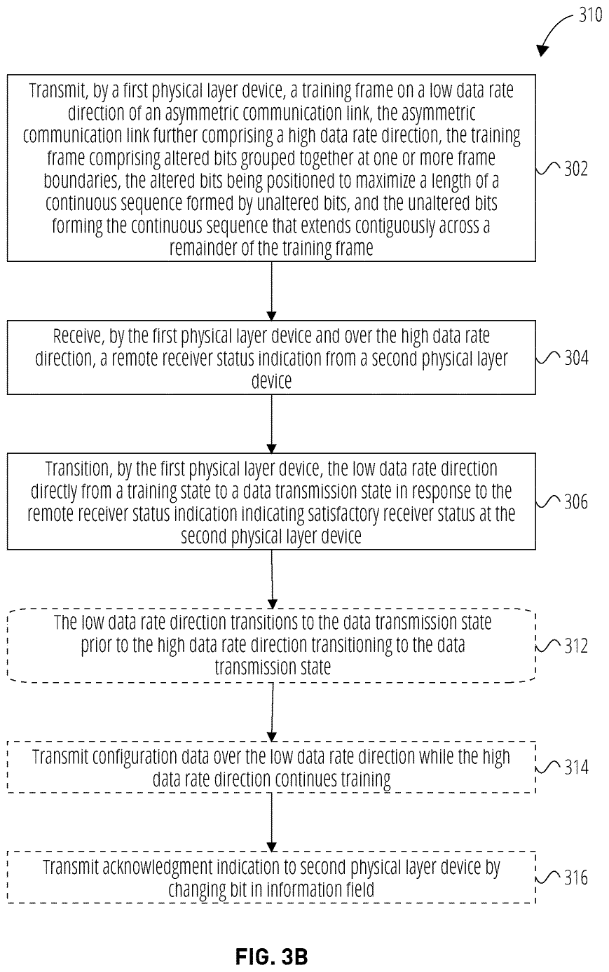

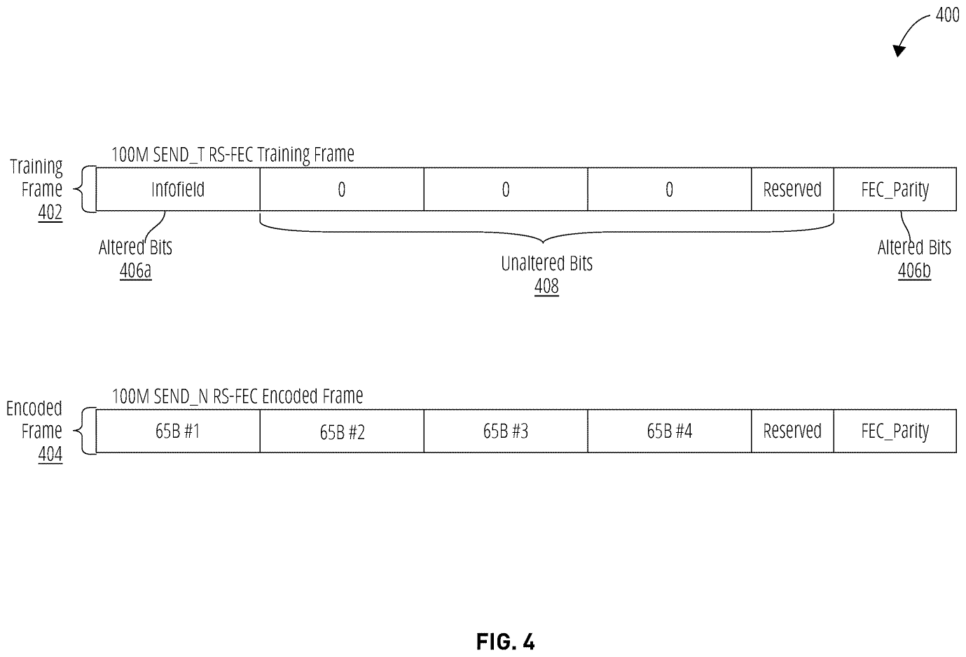

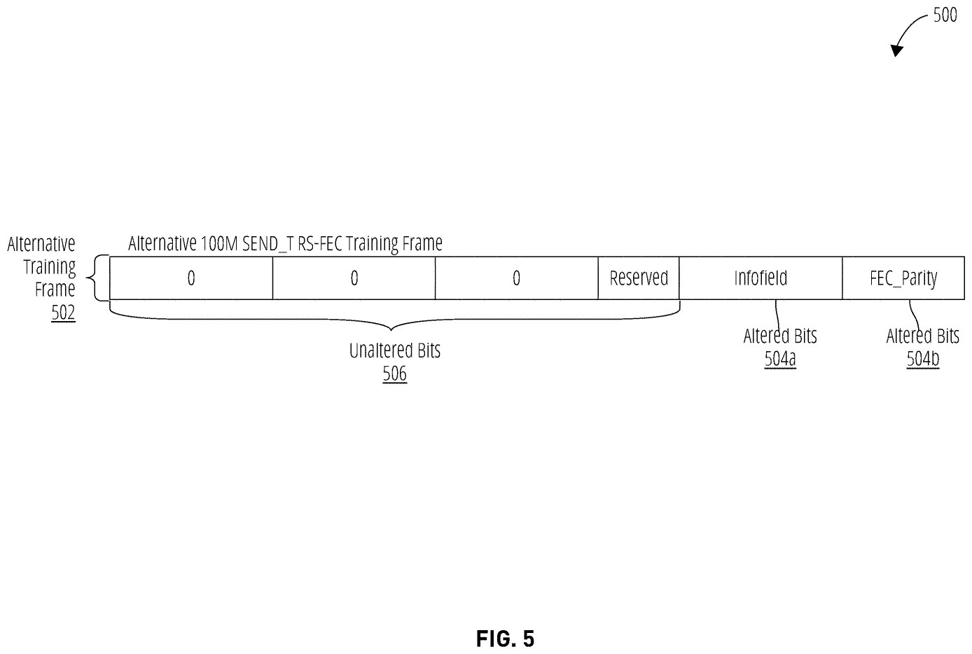

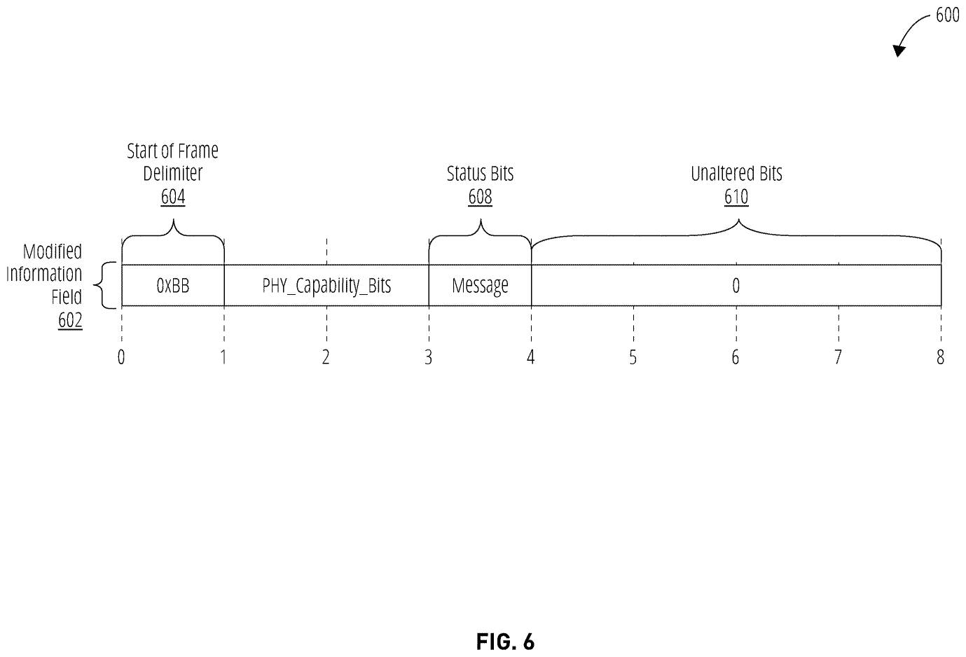

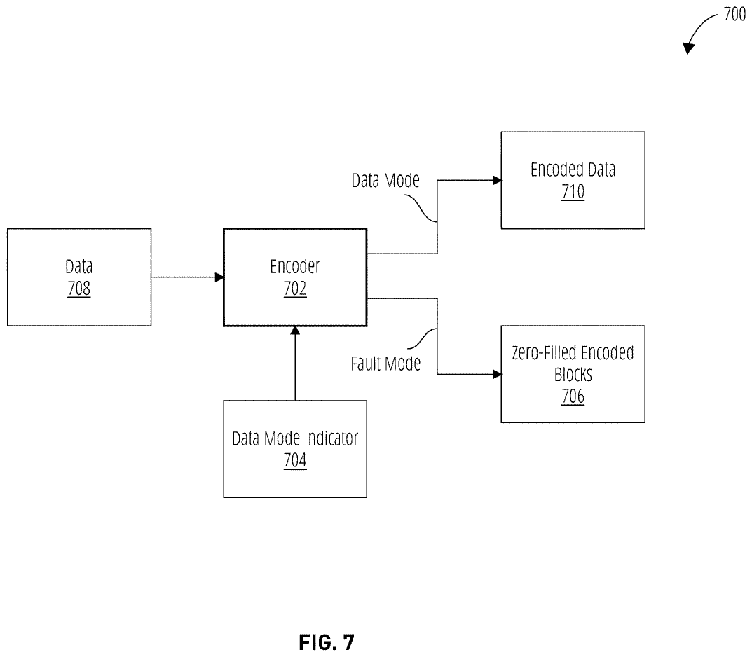

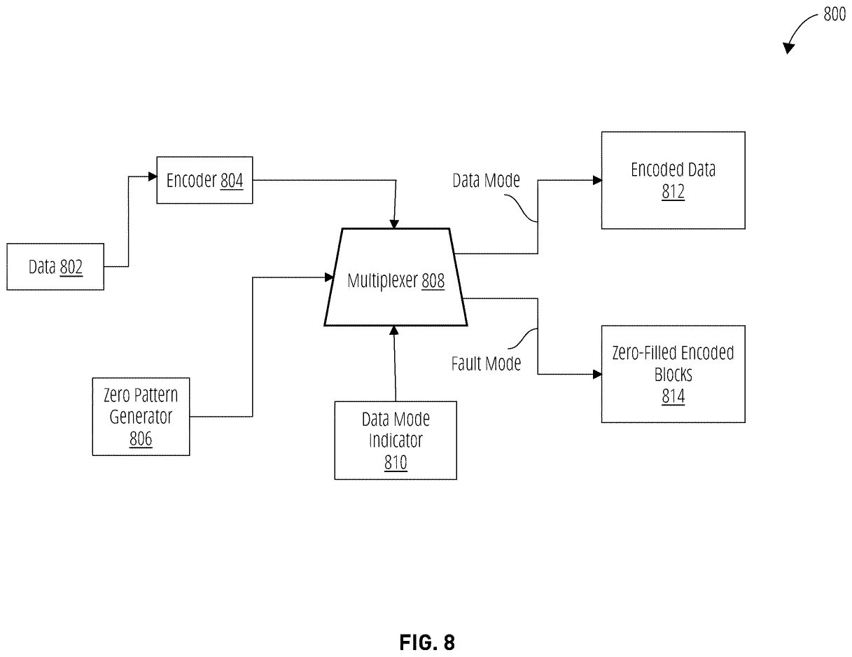

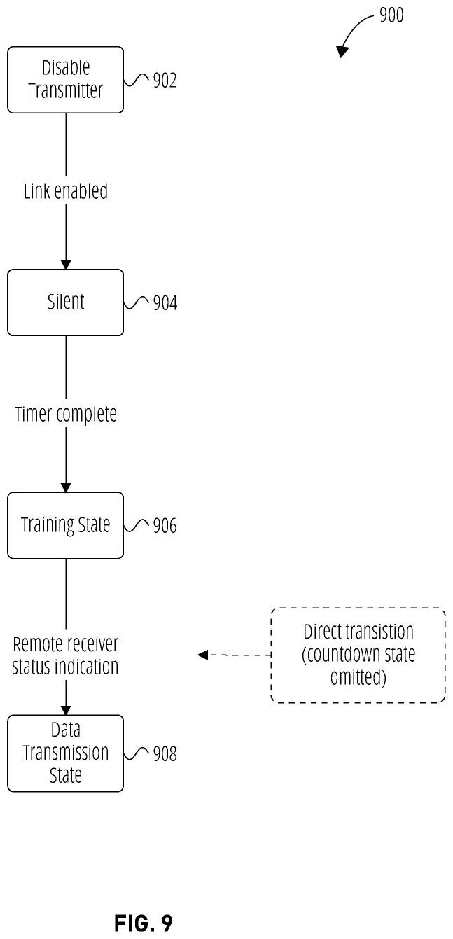

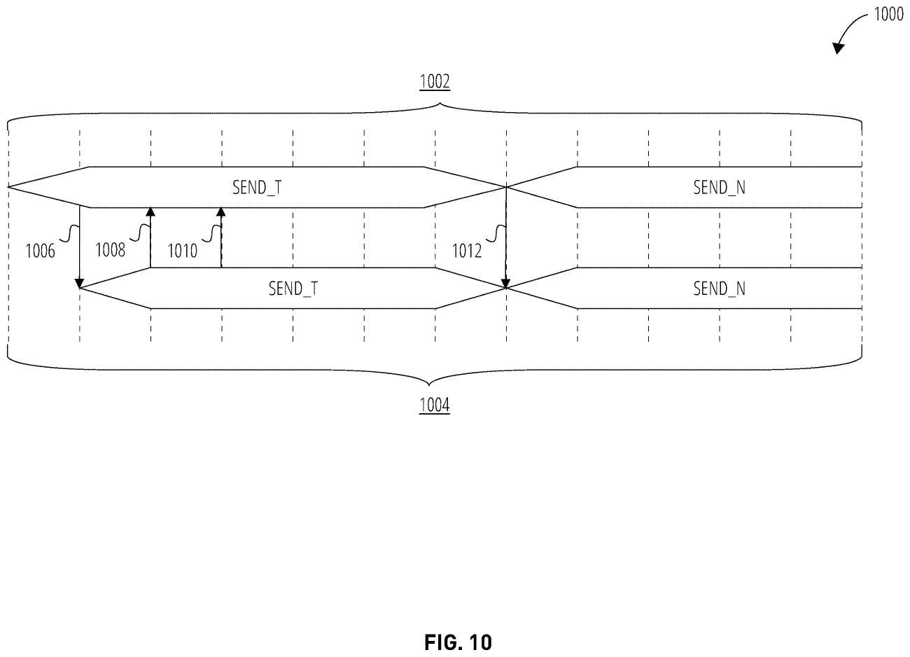

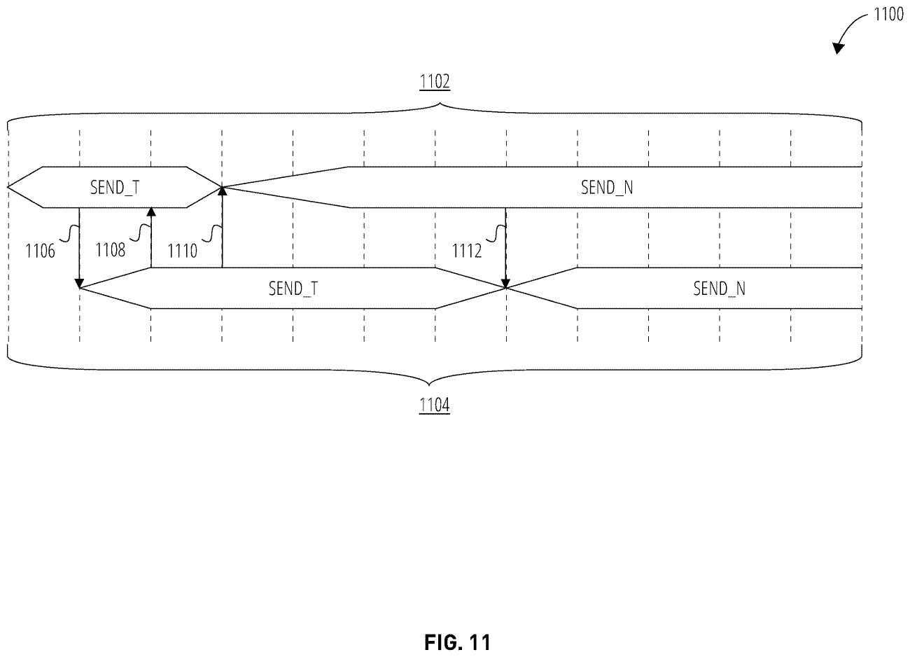

The following description refers to the accompanying drawings. FIG. 1A illustrates a block diagram of an asymmetric communication link connecting physical layer devices, and FIG. 1B illustrates a detailed block diagram of a first transmitter of the first physical layer device. FIG. 2 illustrates a block diagram of an asymmetric communication system showing physical layer devices connected via a communication medium. FIGS. 3A and 3B illustrate flowcharts for methods for training and transitioning an asymmetric communication link, with FIG. 3B depicting optional steps for asymmetric transition and configuration data transmission. FIGS. 4 and 5 illustrate training frame structures showing altered bits grouped at frame boundaries and unaltered bits forming a continuous sequence that extends contiguously across a remainder of the training frame, and FIG. 6 illustrates a modified information field view showing the internal structure of a modified information field. FIGS. 7 and 8 illustrate encoder systems configured to produce zero-filled encoded blocks during training, with FIG. 7 depicting an encoder of a first physical layer device operating in a fault mode and FIG. 8 depicting a multiplexer-based selection approach. FIG. 9 illustrates a state diagram for a PHY control state machine controlling transmissions on a low data rate direction. FIGS. 10 and 11 illustrate timing diagrams for an asymmetric communication link, with FIG. 10 depicting a synchronous transition where both directions transition to data transmission at substantially the same time and FIG. 11 depicting an asynchronous transition where the low data rate direction transitions to data transmission prior to the high data rate direction.

FIG. 1A illustrates an asymmetric communication link 124 connecting a first physical layer device 100 and a second physical layer device 110. The asymmetric communication link 124 supports bidirectional communication with different data rates in each direction, including a low data rate direction 126 and a high data rate direction 128. The first physical layer device 100 may comprise an electronic control unit or a switch. The second physical layer device 110 may comprise a camera module. In some aspects, the asymmetric communication link 124 may be implemented as an automotive camera link connecting the camera module to the electronic control unit or switch.

The first physical layer device 100 includes a first controller 102, a first transmitter 104, and a first receiver 106. The first controller 102 manages operations and coordinates state transitions within the first physical layer device 100. The first transmitter 104 is configured to transmit a training frame 118 on the low data rate direction 126 of the asymmetric communication link 124. The first receiver 106 is configured to receive signals from the high data rate direction 128.

The second physical layer device 110 includes a second controller 108, a second transmitter 112, and a second receiver 114. The second controller 108 manages operations and coordinates state transitions within the second physical layer device 110. In some aspects, the second controller 108 is configured to extract timing information from a continuous sequence formed by unaltered bits within the training frame 118 to facilitate timing recovery. The second transmitter 112 is configured to transmit signals over the high data rate direction 128, including a remote receiver status indication 122. The second receiver 114 is configured to receive the training frame 118 from the low data rate direction 126.

The low data rate direction 126 carries the training frame 118 from the first physical layer device 100 to the second physical layer device 110. The high data rate direction 128 carries the remote receiver status indication 122 from the second physical layer device 110 to the first physical layer device 100. The remote receiver status indication 122 enables the first physical layer device 100 to transition, via a state machine that omits a countdown state, the low data rate direction 126 directly from a training state to a data transmission state in response to the remote receiver status indication 122 indicating satisfactory receiver status at the second physical layer device 110, wherein the transitioning occurs without requiring a local receiver status of the first physical layer device 100 to indicate satisfactory operation.

The first physical layer device 100 operates as the leader in establishing the asymmetric communication link 124. The second physical layer device 110 operates as the follower and synchronizes a transmit frame of the second physical layer device 110 to the timing of the first physical layer device 100. In configurations where the first physical layer device 100 comprises an electronic control unit or switch and the second physical layer device 110 comprises a camera module, the low data rate direction 126 carries control and configuration data toward the camera module while the high data rate direction 128 carries video data from the camera module toward the electronic control unit or switch.

FIG. 1B illustrates a detailed block diagram of the first transmitter 104 of the first physical layer device 100. The first transmitter 104 may include a frame generator 130 and a modulator 132, shown in dashed lines in FIG. 1B to indicate optional components. In some aspects, the frame generator 130 is configured to produce the training frame 118 with altered bits grouped together at one or more frame boundaries, the frame generator 130 positioning the altered bits to maximize a length of a continuous sequence of unaltered bits, and the frame generator 130 producing unaltered bits that form a continuous sequence extending contiguously across a remainder of the training frame 118. In some aspects, the modulator 132 is configured to apply a common modulation scheme for both training frame transmission and data frame transmission on the low data rate direction 126. In some aspects, the modulator 132 applies two-level pulse amplitude modulation (PAM2) for both training and data transmission on the low data rate direction 126. The frame generator 130 provides the training frame 118 to the modulator 132, and the modulator 132 modulates the training frame 118 for transmission over the low data rate direction 126.

FIG. 2 illustrates an asymmetric communication link configuration 200 in accordance with aspects of the present disclosure. The asymmetric communication link configuration 200 includes a first physical layer device 202 and a second physical layer device 204 connected via a communication medium 206. The asymmetric communication link configuration 200 supports bidirectional communication with different data rates in each direction, including a low data rate direction 208 and a high data rate direction 210.

The first physical layer device 202 may comprise an electronic control unit or a switch. The second physical layer device 204 may comprise a camera module, a radar module, a lidar module, or another sensor device. The communication medium 206 provides a bidirectional communication path between the first physical layer device 202 and the second physical layer device 204. In some aspects, the communication medium 206 may comprise a shielded balanced pair of conductors supporting automotive electromagnetic compatibility (EMC) and temperature requirements. The communication medium 206 may support operation with up to two in-line connectors to facilitate installation and maintenance.

The low data rate direction 208 carries control and configuration data from the first physical layer device 202 toward the second physical layer device 204. The high data rate direction 210 carries high-bandwidth data, such as video data or sensor data, from the second physical layer device 204 toward the first physical layer device 202. The asymmetric communication link configuration 200 enables the first physical layer device 202 to transmit training frames and configuration data to the second physical layer device 204 over the low data rate direction 208 while receiving high-bandwidth content over the high data rate direction 210.

The asymmetric communication link configuration 200 may be implemented in various applications including, but not limited to, automotive camera links connecting camera modules to electronic control units or switches, automotive radar and lidar sensor links where high-bandwidth sensor data flows from a sensor to a central processing unit while low-bandwidth configuration and control data flows in the opposite direction, industrial machine vision systems for factory automation quality inspection and robotic guidance, medical imaging equipment including endoscopic cameras and surgical visualization systems, unmanned aerial vehicle camera systems for drone-mounted cameras and sensors, security and surveillance camera networks for Internet Protocol (IP)-based surveillance cameras, consumer electronics display interfaces for televisions, monitors, and head-mounted displays, and satellite and aerospace sensor links for space-based imaging sensors and scientific instruments.

FIG. 3A illustrates a method 300 for training and transitioning an asymmetric communication link. The method 300 enables a first physical layer device (e.g., first physical layer device 100 of FIG. 1A or first physical layer device 202 of FIG. 2) to transition a low data rate direction of an asymmetric communication link to data transmission in response to a remote receiver status indication indicating satisfactory receiver status received from a second physical layer device (e.g., second physical layer device 110 of FIG. 1A or second physical layer device 204 of FIG. 2).

The method 300 begins at a block 302, where the first physical layer device transmits a training frame on a low data rate direction of an asymmetric communication link (e.g., asymmetric communication link 124 of FIG. 1A or asymmetric communication link configuration 200 of FIG. 2). The asymmetric communication link further has a high data rate direction (e.g., high data rate direction 128 of FIG. 1A or high data rate direction 210 of FIG. 2). The training frame (e.g., training frame 118 of FIG. 1A) comprises altered bits grouped together at one or more frame boundaries. The altered bits are positioned to maximize a length of a continuous sequence formed by unaltered bits. The training frame further comprises unaltered bits forming the continuous sequence that extends contiguously across a remainder of the training frame. By grouping the altered bits together at the frame boundaries, the training frame provides an extended continuous sequence of unaltered bits that facilitates pseudo-random binary sequence locking and timing recovery at a receiver of the second physical layer device (e.g., second receiver 114 of FIG. 1A).

With continued reference to FIG. 3A, the method 300 proceeds to a block 304, where the first physical layer device receives, over the high data rate direction, a remote receiver status indication from the second physical layer device. The remote receiver status indication (e.g., remote receiver status indication 122 of FIG. 1A) indicates the operational status or readiness of a receiver at the second physical layer device. In some aspects, the remote receiver status indication may be communicated via one or more status bits within an information field of a training frame transmitted by the second physical layer device over the high data rate direction. The status bits may include a local receiver status bit that the second physical layer device sets to indicate that the receiver at the second physical layer device has achieved satisfactory operation on the low data rate direction.

The method 300 continues to a block 306, where the first physical layer device transitions the low data rate direction directly from a training state to a data transmission state in response to the remote receiver status indication indicating satisfactory receiver status at the second physical layer device. In some aspects, the transition to the data transmission state occurs independent of a local receiver status of the first physical layer device, without being conditioned on the local receiver status of the first physical layer device to indicate satisfactory operation. This independent transition enables the low data rate direction to complete training and begin data transmission without waiting for the high data rate direction to complete training. In some aspects, the first physical layer device may begin transmitting data frames on the low data rate direction while the high data rate direction continues training, enabling transmission of configuration data or initialization data to the second physical layer device prior to the high data rate direction entering the data transmission state.

FIG. 3B illustrates a method 310 for training and transitioning an asymmetric communication link with optional steps. Optional steps are shown in dashed lines. The method 310 includes blocks 302, 304, and 306 as described with reference to FIG. 3A, and further includes optional blocks 312, 314, and 316.

At a block 312, indicated by dashed lines in FIG. 3B, the low data rate direction (e.g., low data rate direction 126 of FIG. 1A or low data rate direction 208 of FIG. 2) transitions to the data transmission state prior to the high data rate direction (e.g., high data rate direction 128 of FIG. 1A or high data rate direction 210 of FIG. 2) transitioning to the data transmission state. This asymmetric transition enables the low data rate direction to complete training and begin data transmission before the high data rate direction completes training. In configurations where the first physical layer device (e.g., first physical layer device 100 of FIG. 1A or first physical layer device 202 of FIG. 2) comprises an electronic control unit or switch and the second physical layer device (e.g., second physical layer device 110 of FIG. 1A or second physical layer device 204 of FIG. 2) comprises a camera module, the low data rate direction may transition to the data transmission state while the high data rate direction continues training operations including clock and data recovery acquisition, timing recovery, equalizer training, and echo cancellation.

At a block 314, indicated by dashed lines in FIG. 3B, the first physical layer device transmits configuration data over the low data rate direction while the high data rate direction continues training. Camera sensor initialization may require transmission of a substantial amount of configuration data toward the camera, including sensor register settings, operating mode parameters, timing configurations, and calibration data. The configuration data may include camera sensor initialization parameters, operating mode settings, or other control information that the second physical layer device uses to configure operation prior to the high data rate direction entering the data transmission state. By transmitting configuration data over the low data rate direction while the high data rate direction continues training, the method 310 reduces the overall time to establish a fully operational communication link. In applications such as automotive camera links, this enables camera sensor initialization to proceed while the high data rate direction continues training, reducing camera link readiness time.

At a block 316, indicated by dashed lines in FIG. 3B, the first physical layer device receives a link synchronization signal from the second physical layer device and transmits an acknowledgment indication to the second physical layer device by changing a bit in an information field of the training frame. The acknowledgment indication confirms receipt of the link synchronization signal. In some aspects, the acknowledgment indication comprises a bit transition in the information field that the first physical layer device sets upon successful decoding of the link synchronization signal. The closed-loop acknowledgment mechanism addresses synchronization failures that could otherwise occur when channel noise corrupts acknowledgments in open-loop approaches.

FIG. 4 illustrates a frame structure comparison 400 between a training frame 402 and an encoded frame 404 for a low data rate direction of an asymmetric communication link. As described previously, the training frame 402 comprises altered bits grouped together at one or more frame boundaries, with the altered bits being positioned to maximize a length of a continuous sequence formed by unaltered bits. The training frame 402 further comprises unaltered bits forming the continuous sequence that extends contiguously across a remainder of the training frame 402.

As shown in FIG. 4, altered bits 406a are positioned at a first frame boundary and altered bits 406b are positioned at a second frame boundary, thereby maximizing the continuous sequence of unaltered bits 408 within the training frame 402. The altered bits 406a and the altered bits 406b comprise an information field and forward error correction parity bits. The training frame 402 comprises a forward error correction frame structure with the information field positioned at the first frame boundary, the forward error correction parity bits positioned at the second frame boundary, and the continuous sequence of unaltered bits 408 positioned between the information field and the forward error correction parity bits.

In some aspects, the training frame 402 may employ Reed-Solomon forward error correction with RS-FEC(50,46,6) encoding generating 24 parity bits from a 276-bit message. The training frame 402 may comprise a 300-bit RS-FEC frame structure containing a 12-octet information field, four zero-filled 64B/65B block positions totaling 260 bits, a 16-bit reserved field, and 24-bit FEC parity. The field ordering positions the information field at the first frame boundary and the forward error correction parity bits at the second frame boundary, maximizing the continuous sequence of unaltered bits 408 in the middle of the training frame 402 to facilitate pseudo-random binary sequence locking, timing recovery, and clock recovery.

FIG. 5 illustrates an alternative training frame structure 500 for a low data rate direction of an asymmetric communication link. The alternative training frame structure 500 depicts a field ordering arrangement that positions altered bits adjacent to each other at one end of the frame.

The alternative training frame 502 comprises altered bits 504a and altered bits 504b positioned adjacent to each other at a right boundary of the alternative training frame 502. The altered bits 504a comprise an information field, and the altered bits 504b comprise forward error correction parity bits. By positioning the altered bits 504a and the altered bits 504b adjacent to each other at one end of the alternative training frame 502, the alternative training frame structure 500 maximizes the length of a continuous sequence of unaltered bits 506 at the opposite end of the frame.

The unaltered bits 506 form a continuous sequence that extends across a left portion of the alternative training frame 502. The unaltered bits 506 comprise zero-filled encoded blocks. The zero-filled encoded blocks are distinct from encoded blocks with all-zero payload data that may be present in data frames; a distinguishing characteristic such as an information field signature enables a receiving device to differentiate between training frames containing zero-filled encoded blocks and data frames containing encoded blocks with all-zero payload data. The alternative training frame 502 further includes a reserved field adjacent to the unaltered bits 506. The continuous sequence of unaltered bits 506 facilitates pseudo-random binary sequence locking, timing recovery, and clock recovery by providing an extended uninterrupted pattern for receiver synchronization.

Beyond the arrangement shown in FIG. 5, other field orderings are contemplated. In some aspects, the training frame structure may position the information field and forward error correction parity at the beginning of the frame with zero-filled encoded blocks and a reserved field at the end, as an alternative to positioning altered bits at the end of the frame with zero-filled blocks at the beginning. The field ordering may be selected based on implementation considerations and receiver architecture.

In some aspects, the training frame structure may interleave altered bits at fixed intervals while maintaining a minimum continuous zero sequence length sufficient for pseudo-random binary sequence synchronization. The interleaved arrangement distributes altered bits throughout the frame at predetermined positions while preserving a continuous sequence of unaltered bits of sufficient length for receiver adaptation. The interleaved arrangement may provide benefits for certain receiver implementations that process frame content at regular intervals.

In some aspects, the training frame structure may use a variable field ordering that adapts based on a minimum unaltered sequence length for a given receiver implementation. The variable field ordering enables the training frame structure to accommodate different receiver architectures that may have different minimum continuous zero sequence length specifications for pseudo-random binary sequence locking and timing recovery. This flexibility provides compatibility across a range of receiver designs without requiring changes to the underlying frame structure. The following paragraphs describe additional aspects of the training frame structure, including the modified information field.

FIG. 6 illustrates a modified information field view 600 showing an internal structure of a modified information field 602 for a training frame. The modified information field 602 comprises a start of frame delimiter 604, status bits 608, and unaltered bits 610.

The start of frame delimiter 604 has a value of 0xBB and occupies a first portion of the modified information field 602. The start of frame delimiter 604 identifies the training frame and distinguishes the training frame from data frames. The start of frame delimiter 604 serves as a distinguishing characteristic that enables a receiving physical layer device to distinguish between training frames containing zero-filled encoded blocks and data frames containing encoded blocks with all-zero payload data. The modified information field 602 retains the start of frame delimiter 604 to enable a receiving physical layer device to recognize the training frame.

The modified information field 602 includes PHY capability bits that are repositioned from their conventional location. In a conventional information field, PHY capability bits occupy octets 8, 9, and 10. In the modified information field 602, the PHY capability bits are repositioned to follow the start of frame delimiter 604, occupying positions adjacent to the start of frame delimiter within the modified field structure. The PHY capability bits may include fields for VendorSpecificData, InterleaverDepth, ProceedRequest, SkewVariation, and EEEMac. The PHY capability bits enable physical layer devices to exchange capability information during training.

The status bits 608 contain a message field for exchanging link state information between physical layer devices. The message field includes loc_rcvr_status, en_slave_tx, and timing_lock_OK status bits. The loc_rcvr_status status bit indicates the operational status of a local receiver at a transmitting physical layer device. The en_slave_tx status bit enables a follower physical layer device to begin transmission. The timing_lock_OK status bit indicates that timing acquisition has been achieved. The status bits 608 enable physical layer devices to coordinate state transitions during training. In some aspects, a remote receiver status indication may be communicated via one or more of the status bits 608 within the modified information field 602.

The unaltered bits 610 extend across a remainder of the modified information field 602. The unaltered bits 610 comprise zeros and form a continuous sequence that facilitates receiver synchronization and timing recovery. In some aspects, a controller at a receiving physical layer device may extract timing information from the continuous sequence of unaltered bits 610 to facilitate timing recovery.

The modified information field 602 eliminates a partial frame count field that is rendered not utilized by the omission of a countdown state from a state machine controlling transmissions on the low data rate direction. The partial frame count field, which occupies octets 4, 5, and 6 in a conventional information field, coordinates timing for transitions between different transmission modes during a countdown state. In configurations where a common modulation is employed for both training and data transmission in the low data rate direction, the countdown state is omitted, and the partial frame count field is no longer utilized. The elimination of the partial frame count field increases the length of the unaltered bit sequence within the training frame.

In some aspects, the modified information field 602 may eliminate the partial frame count field while retaining a 16-bit cyclic redundancy check (CRC16) field for additional integrity checking beyond Reed-Solomon forward error correction. In some aspects, the modified information field 602 may eliminate the CRC16 field while retaining the partial frame count field as reserved bits for future use. In some aspects, the modified information field 602 may replace eliminated octets with vendor-specific data fields rather than reserved bits.

The modified information field 602 is XORed with a first 96 bits of a 16th partial frame during training frame encoding. The XOR operation combines the modified information field 602 with a known pattern to produce the transmitted information field content. This XOR encoding enables the receiver to identify and extract the information field content by applying the same known pattern during decoding. The encoding approach maintains compatibility with the training frame structure while enabling the information field to be distinguished from the zero-filled portions of the frame.

FIG. 7 illustrates an encoder system 700 of a first physical layer device configured to produce zero-filled encoded blocks during training, in accordance with aspects of the present disclosure. The encoder system 700 includes an encoder 702, a data mode indicator 704, data 708, encoded data 710, and zero-filled encoded blocks 706.

The encoder 702 receives data 708 as an input and produces output based on a state of the data mode indicator 704. The data mode indicator 704 provides a control signal to the encoder 702 that determines an operating mode of the encoder 702. When the data mode indicator 704 is asserted, the encoder 702 processes the data 708 and produces encoded data 710 as output. When the data mode indicator 704 is deasserted, the encoder 702 operates in a fault mode and produces zero-filled encoded blocks 706 as output. In the fault mode, the encoder 702 substitutes a predetermined zero pattern for the encoded output, bypassing normal encoding of the data 708 and instead generating a fixed zero-filled block structure that maintains the expected block format while containing zero values in the data portion.

As described previously, the unaltered bits within a training frame may comprise zero-filled encoded blocks. The zero-filled encoded blocks 706 are produced by operating the encoder 702 of the first physical layer device in the fault mode while the data mode indicator 704 of the first physical layer device is deasserted. In some aspects, the encoder 702 may comprise a 64B/65B encoder that produces zero-filled 64B/65B blocks when operating in a local fault mode. In some aspects, the encoder 702 may comprise an 8B/10B encoder, a 128B/130B encoder, or another block encoder that produces zero-filled encoded blocks when operating in a fault mode. The encoder 702 may implement other encoding schemes that support a fault mode or equivalent operating mode for generating zero-filled output patterns. The zero-filled encoded blocks 706 form part of the unaltered bits within a training frame structure, contributing to the continuous sequence of unaltered bits that facilitates receiver synchronization and timing recovery. In some aspects, a controller at a receiving physical layer device may extract timing information from the continuous sequence of unaltered bits to facilitate timing recovery.

The training frame comprises a distinguishing characteristic that differentiates the training frame from data frames. The distinguishing characteristic enables a second physical layer device (e.g., second physical layer device 110 of FIG. 1A or second physical layer device 204 of FIG. 2) to distinguish between training frames containing zero-filled encoded blocks and data frames containing encoded blocks with all-zero payload data. In some aspects, the distinguishing characteristic may comprise an information field signature, such as a start of frame delimiter having a value of 0xBB that identifies the training frame. The presence of the information field structure within the training frame differentiates training frames from data frames that may contain encoded blocks with all-zero payload data.

FIG. 8 illustrates an encoder system 800 with multiplexer-based selection, according to an alternative embodiment. The encoder system 800 provides an alternative approach for producing zero-filled encoded blocks during training operations.

The encoder system 800 includes data 802, an encoder 804, a zero pattern generator 806, a multiplexer 808, a data mode indicator 810, encoded data 812, and zero-filled encoded blocks 814. The data 802 represents input data to be encoded and is provided to the encoder 804. The encoder 804 processes the data 802 to produce encoded output according to an encoding scheme, such as 64B/65B encoding.

The zero pattern generator 806 generates predetermined zero patterns for use during training. In some aspects, the zero pattern generator 806 generates zero-filled 64B/65B block patterns or other block formats consistent with the encoding scheme employed by the encoder 804. The zero pattern generator 806 provides zero-filled patterns to the multiplexer 808 as one input. The encoder 804 provides encoded output to the multiplexer 808 as another input.

The multiplexer 808 receives multiple inputs and selects between the inputs based on a control signal from the data mode indicator 810. The data mode indicator 810 provides the control signal to the multiplexer 808 that determines which input is selected for output. When the data mode indicator 810 indicates a data mode, the multiplexer 808 selects the output from the encoder 804, producing encoded data 812 as the output. When the data mode indicator 810 indicates a training mode, the multiplexer 808 selects the output from the zero pattern generator 806, producing zero-filled encoded blocks 814 as the output.

The multiplexer-based configuration enables switching between normal encoded data and zero-filled blocks based on the state of the data mode indicator 810. This configuration provides an alternative to operating the encoder 804 in a fault mode to produce zero-filled encoded blocks. The multiplexer-based selection allows the encoder 804 to continue normal operation while the zero pattern generator 806 provides the zero-filled patterns used during training. The encoder system 800 supports the production of training frames containing zero-filled encoded blocks that form a continuous sequence of unaltered bits within the training frame structure.

In some aspects, the encoder 804 may use a dedicated training mode that outputs predetermined zero patterns as an alternative to local fault mode. In the dedicated training mode, the encoder 804 receives a training mode signal and produces zero-filled encoded blocks directly without requiring the multiplexer 808 to select between encoder output and zero pattern generator output. The dedicated training mode may simplify the signal path during training by eliminating the multiplexer selection.

In some aspects, the encoder 804 may be bypassed entirely during training and zero-filled block patterns may be directly inserted into the training frame. In this configuration, the zero pattern generator 806 provides zero-filled encoded blocks 814 directly to the output path while the encoder 804 remains idle or disabled. The encoder bypass insertion reduces power consumption during training by disabling encoder circuitry that is not utilized when zero-filled blocks are transmitted.

In some aspects, the training frame may use a distinct preamble pattern preceding the training frame for enhanced frame differentiation. The distinct preamble pattern enables a receiving physical layer device to identify the beginning of a training frame and distinguish training frames from data frames based on the preamble content.

In some aspects, the training frame may use a dedicated sync header bit pattern that differs between training and data modes. The dedicated sync header bit pattern provides an additional mechanism for a receiving physical layer device to distinguish between training frames and data frames based on the sync header content within each encoded block.

In some aspects, a mode indicator may be encoded within a reserved field of the frame structure to differentiate training frames from data frames. The mode indicator within the reserved field provides an alternative or supplemental mechanism for frame differentiation that does not rely on the information field signature or sync header bit patterns.

FIG. 9 illustrates a state diagram 900 for a PHY control state machine controlling transmissions on the low data rate direction (e.g., low data rate direction 126 of FIG. 1A or low data rate direction 208 of FIG. 2). The state diagram 900 includes a disable transmitter state 902, a silent state 904, a training state 906, and a data transmission state 908.

The disable transmitter state 902 represents an initial state where a transmitter of a first physical layer device (e.g., first physical layer device 100 of FIG. 1A or first physical layer device 202 of FIG. 2) is disabled. When a link is enabled, the state diagram 900 transitions from the disable transmitter state 902 to the silent state 904. The silent state 904 represents a state where the transmitter remains inactive for a timer period. When the timer completes, the state diagram 900 transitions from the silent state 904 to the training state 906. The training state 906 represents a state during which the first physical layer device transmits training frames on the low data rate direction to enable receiver adaptation at a second physical layer device (e.g., second physical layer device 110 of FIG. 1A or second physical layer device 204 of FIG. 2). When a remote receiver status indication indicating satisfactory receiver status at the second physical layer device is received, the state diagram 900 transitions directly from the training state 906 to the data transmission state 908. The data transmission state 908 represents a state during which the first physical layer device transmits data frames carrying payload information over the low data rate direction.

As described previously, the low data rate direction may employ a common modulation for training and data transmission. The state diagram 900 omits a countdown state, a transmit switch state, and a test state that are present in a state machine controlling transmissions on the high data rate direction. The countdown state is omitted based on the common modulation being employed for training and data transmission in the low data rate direction. In configurations where the high data rate direction employs a first modulation for training and a second modulation different from the first modulation for data transmission, the state machine controlling transmissions on the high data rate direction includes the countdown state to coordinate the modulation transition. In the low data rate direction, where no modulation change occurs between training and data transmission, the countdown state has no function and is omitted from the state diagram 900.

The omission of the countdown state enables the low data rate direction to transition directly from the training state 906 to the data transmission state 908 in response to the remote receiver status indication indicating satisfactory receiver status at the second physical layer device, wherein the transitioning occurs without requiring a local receiver status of the first physical layer device to indicate satisfactory operation. The state diagram 900 reduces the number of states from seven states in the high data rate direction state machine to four states in the low data rate direction state machine, simplifying the control logic while maintaining full functionality for the low data rate direction.

In some aspects, the state machine may retain the countdown state but set a duration of the countdown state to zero for the low data rate direction. In this configuration, the state machine includes the countdown state in the state sequence, but the countdown state completes instantaneously without introducing delay between the training state and the data transmission state.

In some aspects, the state machine may replace the countdown state with a simplified ready-check state that does not coordinate modulation transitions. The simplified ready-check state may verify receiver readiness without performing the modulation coordination functions associated with the countdown state in the high data rate direction.

In some aspects, countdown functionality may be merged into the training state with conditional execution based on modulation specifications. In this configuration, the training state includes logic that conditionally executes countdown operations when a modulation change is indicated and bypasses countdown operations when a common modulation is employed for training and data transmission.

In some aspects, the state machine may transition from the disable transmitter state directly to the training state to the data transmission state using three states instead of four states. In this configuration, the silent state is omitted, and the state machine proceeds directly from the disable transmitter state to the training state when the link is enabled.

In some aspects, the state machine may retain all states but with zero-duration transitions for states not utilized in the low data rate direction. In this configuration, the state machine includes the countdown state, the transmit switch state, and the test state, but each of these states completes with zero duration, effectively bypassing the states while maintaining the state sequence structure.

In some aspects, the state machine may be configurable, where states are enabled or disabled based on link configuration parameters. In this configuration, a configuration register or other control mechanism determines which states are active in the state machine, enabling the same state machine implementation to support both the low data rate direction and the high data rate direction with different state configurations.

In some aspects, a local receiver status condition may be made optional based on a configuration bit rather than being removed entirely. In this configuration, a configuration bit determines whether the transition from the training state to the data transmission state depends on the local receiver status to indicate satisfactory operation, enabling the state machine to operate in either a mode that is conditioned on local receiver status or a mode that transitions based on remote receiver status alone.

In some aspects, a timeout mechanism may allow transition to the data transmission state if a local receiver status is not received within a specified period. In this configuration, the state machine transitions from the training state to the data transmission state based on the remote receiver status indication, and if the local receiver status is not received within the specified period, the state machine proceeds with the transition rather than waiting indefinitely.

In some aspects, priority-based transition logic may be implemented where the remote receiver status indication is sufficient for transition but the local receiver status can accelerate the transition. In this configuration, the state machine transitions from the training state to the data transmission state when the remote receiver status indication is received, and the presence of a satisfactory local receiver status may enable the transition to occur sooner than when relying on the remote receiver status indication alone.

The low data rate direction employs differential Manchester encoding for transmission over a physical medium. Differential Manchester encoding represents data through signal transitions rather than signal levels, enabling receivers to extract timing information from the transmitted signal. The low data rate direction uses PAM2 modulation, also referred to as two-level pulse amplitude modulation, for both training and data transmission. The training signal in the low data rate direction contains the symbols {−1, +1}. Because the low data rate direction employs PAM2 modulation for both training and data transmission, no modulation change occurs between training and data modes in the low data rate direction. This common modulation for training and data transmission in the low data rate direction enables the omission of a countdown state from a state machine controlling transmissions on the low data rate direction, as described previously.

The high data rate direction employs a first modulation for training and a second modulation different from the first modulation for data transmission. The first modulation comprises PAM2 modulation, and the second modulation comprises PAM4 modulation, also referred to as four-level pulse amplitude modulation. PAM4 modulation transmits one of four distinct amplitude levels per symbol period, providing higher information throughput compared to PAM2 modulation. The transition from PAM2 to PAM4 in the high data rate direction occurs during a countdown state, which coordinates the modulation transition between training and data transmission. The state machine controlling transmissions on the high data rate direction retains the countdown state to coordinate the PAM2 to PAM4 modulation transition.

A physical coding sublayer (PCS) employs side-stream scrambling to improve electromagnetic compatibility (EMC) performance of the transmitted signal. The PCS uses different scrambler generator polynomials for leader and slave physical layer device configurations. A leader physical layer device employs a first scrambler generator polynomial, and a slave physical layer device employs a second scrambler generator polynomial different from the first scrambler generator polynomial. For side-stream descrambling, a leader physical layer device employs a receiver descrambler generator polynomial corresponding to the slave scrambler polynomial, and a slave physical layer device employs a receiver descrambler generator polynomial corresponding to the leader scrambler polynomial. The scrambler randomizes data patterns to produce a varying signal pattern that enables timing recovery circuitry to extract clock information from the transmitted signal.

The asymmetric communication link supports crystal-less configurations where a clock offset between communicating physical layer devices may be notable. In crystal-less configurations, a physical layer device lacks a local crystal oscillator and derives operational timing from a received signal rather than from a local precision clock reference. The clock offset in crystal-less configurations may be as high as 20 percent. The continuous signal transmission during link synchronization enables a receiving physical layer device to recover the clock from the transmitted signal. The extended continuous sequence of unaltered bits within the training frame supports clock recovery by providing a consistent pattern for timing acquisition. In some aspects, a controller at a receiving physical layer device may extract timing information from the continuous sequence of unaltered bits to facilitate timing recovery. In crystal-less configurations, the continuous signaling from the start of link synchronization allows training functions to be performed during a link synchronization phase.

FIG. 10 illustrates a synchronous transition timing diagram 1000 for an asymmetric communication link. The synchronous transition timing diagram 1000 depicts timing relationships between a low data rate direction 1002 and a high data rate direction 1004 during a training sequence where both directions transition to data transmission at substantially the same time.

The synchronous transition timing diagram 1000 depicts a sequence of bit exchanges that occur during the training sequence. A bit exchange 1006 occurs in the low data rate direction 1002 during a SEND_T phase (training phase), corresponding to en_slave_tx=1. The en_slave_tx status bit enables a follower physical layer device to begin transmission. A bit exchange 1008 occurs in the low data rate direction 1002 at a subsequent point during the SEND_T phase, corresponding to timing_lock_OK=1. The timing_lock_OK status bit indicates that timing acquisition has been achieved. A bit exchange 1010 occurs in the low data rate direction 1002 at a transition point from SEND_T to SEND_N (normal/data transmission phase), corresponding to loc_rcvr_status=OK for 100M. The loc_rcvr_status status bit indicates the operational status of a local receiver at a transmitting physical layer device. A bit exchange 1012 occurs in the high data rate direction 1004 at a transition point from SEND_T to SEND_N, corresponding to loc_rcvr_status=OK for Multi-Gig.

In the synchronous transition timing diagram 1000, the transition from SEND_T to SEND_N in the low data rate direction 1002 and the transition from SEND_T to SEND_N in the high data rate direction 1004 occur at substantially aligned timing positions. The bit exchange 1010 and the bit exchange 1012 occur at approximately the same time, enabling both directions to enter data transmission mode together. A typical signaling sequence comprises en_slave_tx=1, then timing_lock_OK=1, followed by loc_rcvr_status=OK for the low data rate direction and loc_rcvr_status=OK for the high data rate direction at substantially aligned timing positions.

In some aspects, a configurable synchronization mode enables selection between synchronous and asynchronous transition to data transmission based on system specifications. The configurable synchronization mode may be implemented via a configuration register or other control mechanism that determines whether the low data rate direction and the high data rate direction transition to data transmission at substantially the same time or whether each direction transitions independently based on receiver readiness. In configurations where synchronous transition is selected, both directions coordinate the transition to data transmission as depicted in the synchronous transition timing diagram 1000. In configurations where asynchronous transition is selected, the low data rate direction may transition to data transmission prior to the high data rate direction completing training, as described with reference to FIG. 11.

In some aspects, a delayed synchronous transition mode may be implemented where a faster direction waits for a maximum timeout before proceeding independently. In the delayed synchronous transition mode, the direction that completes training first waits for the other direction to complete training up to a maximum timeout duration. If the other direction completes training within the maximum timeout duration, both directions transition to data transmission at substantially the same time. If the maximum timeout duration expires before the other direction completes training, the faster direction proceeds to data transmission independently. The delayed synchronous transition mode provides a balance between synchronous coordination and reduced link establishment time by enabling the faster direction to proceed after a bounded waiting period.

FIG. 11 illustrates an asynchronous transition timing diagram 1100 for an asymmetric communication link. The asynchronous transition timing diagram 1100 depicts timing relationships between a low data rate direction 1102 and a high data rate direction 1104 during a training sequence where the low data rate direction 1102 transitions to data transmission prior to the high data rate direction 1104 completing training.

The low data rate direction 1102 is shown in an upper portion of the asynchronous transition timing diagram 1100, while the high data rate direction 1104 is shown in a lower portion. Both directions are depicted with SEND_T phases transitioning to SEND_N phases, with vertical dashed lines indicating timing relationships between the two directions.

The asynchronous transition timing diagram 1100 depicts a sequence of bit exchanges that occur during the training sequence. A bit exchange 1106 occurs in the low data rate direction 1102 during a SEND_T phase (training phase), corresponding to en_slave_tx=1. The en_slave_tx status bit enables a follower physical layer device (e.g., second physical layer device 110 of FIG. 1A or second physical layer device 204 of FIG. 2) to begin transmission. A bit exchange 1108 occurs in the low data rate direction 1102 at a subsequent point during the SEND_T phase, corresponding to timing_lock_OK=1. The timing_lock_OK status bit indicates that timing acquisition has been achieved. A bit exchange 1110 occurs in the low data rate direction 1102 at a transition point from SEND_T to SEND_N (normal/data transmission phase), corresponding to loc_rcvr_status=OK for 100M. The loc_rcvr_status status bit indicates the operational status of a local receiver at a transmitting physical layer device. A bit exchange 1112 occurs in the high data rate direction 1104 at a later transition point from SEND_T to SEND_N, corresponding to loc_rcvr_status=OK for Multi-Gig.

In the asynchronous transition timing diagram 1100, the transition from SEND_T to SEND_N in the low data rate direction 1102 occurs prior to the transition from SEND_T to SEND_N in the high data rate direction 1104. The bit exchange 1110 in the low data rate direction 1102 occurs before the bit exchange 1112 in the high data rate direction 1104, illustrating that the low data rate direction 1102 transitions to data transmission independently and earlier than the high data rate direction 1104. A typical signaling sequence comprises en_slave_tx=1, then timing_lock_OK=1, followed by loc_rcvr_status=OK for the low data rate direction 1102, and subsequently loc_rcvr_status=OK for the high data rate direction 1104 at a later timing position.

As described previously, omitting the countdown state from a state machine controlling transmissions on the low data rate direction enables the low data rate direction 1102 to transition to the data transmission state prior to the high data rate direction 1104 transitioning to the data transmission state. The first physical layer device (e.g., first physical layer device 100 of FIG. 1A or first physical layer device 202 of FIG. 2) transmits data frames on the low data rate direction 1102 while the second physical layer device (e.g., second physical layer device 110 of FIG. 1A or second physical layer device 204 of FIG. 2) continues to transmit training frames over the high data rate direction 1104 to enable the first physical layer device to complete training on the high data rate direction 1104. The second physical layer device includes a receiver configured to receive the training frame on the low data rate direction 1102 from the first physical layer device. The second physical layer device further includes a transmitter configured to transmit, over the high data rate direction 1104, a remote receiver status indication to the first physical layer device. The remote receiver status indication indicates the operational status of the receiver at the second physical layer device. In some aspects, the second physical layer device further includes a controller configured to extract timing information from a continuous sequence of unaltered bits within the training frame to facilitate timing recovery. The first physical layer device includes a controller configured to transition the low data rate direction 1102 directly from a training state to a data transmission state in response to the remote receiver status indication indicating satisfactory receiver status at the second physical layer device, wherein the transitioning occurs without requiring a local receiver status of the first physical layer device to indicate satisfactory operation. This configuration enables the first physical layer device to begin data transmission on the low data rate direction 1102 upon receiving confirmation that the second physical layer device has achieved satisfactory receiver operation, without waiting for the high data rate direction 1104 to complete training.

The asynchronous transition timing diagram 1100 illustrates an embodiment where the low data rate direction 1102 completes training and begins data transmission while the high data rate direction 1104 continues training operations including clock and data recovery acquisition, timing recovery, equalizer training, and echo cancellation. This asymmetric transition enables transmission of configuration data over the low data rate direction 1102 prior to the high data rate direction 1104 entering data transmission mode. The following paragraphs describe the link synchronization and training sequence, as well as various signaling mechanisms that may be employed during training.

Having described the asynchronous transition timing, the following paragraphs describe the normal link synchronization and training sequence for the asymmetric communication link. The normal link synchronization and training sequence may comprise five transitions. In a first transition, a leader physical layer device (e.g., first physical layer device 100 of FIG. 1A) begins transmitting a synchronization signal. In a second transition, a follower physical layer device (e.g., second physical layer device 110 of FIG. 1A) detects the leader synchronization signal and begins transmitting a link synchronization response. In a third transition, the leader physical layer device detects the follower signal and begins transmitting a training frame. In a fourth transition, the follower physical layer device detects the leader training frame and begins transmitting a follower training frame. In a fifth transition, the leader physical layer device transmits data frames on the low data rate direction while the follower physical layer device subsequently transmits data frames on the high data rate direction. The follower physical layer device may detect the leader's transition from a synchronization signal to a training frame by observing a change from scrambled zeros to a structured training frame.

In some aspects, the training frame transmitted during the training state may serve as a substitute for a separate synchronization signal during link synchronization. Because the training frame consists of a prolonged series of zeros within the unaltered bit sequence, the training frame provides a viable substitute for a dedicated synchronization signal, enabling combined link synchronization and training where a common signal framing is used for both link synchronization and training operations. This combined approach enables the use of identical signal framing for link synchronization, training, and data modes, reducing implementation complexity by enabling the same hardware to be used across these operational phases.

Beyond the normal link synchronization and training sequence, various alternative signaling mechanisms may be employed to communicate training completion status between physical layer devices. In some aspects, a handshake mechanism may be implemented where the first direction to complete training signals readiness and proceeds after acknowledgment or timeout. The handshake mechanism enables the low data rate direction 1102 to signal training completion to the high data rate direction 1104 and proceed to data transmission upon receiving acknowledgment or upon expiration of a timeout period.

In some aspects, an original equipment manufacturer (OEM) signal mechanism external to the PHY layer may indicate training completion after the leader physical layer device transitions to data transmission. The OEM signal mechanism provides an out-of-band indication that enables coordination of subsequent operations after the leader transitions to data transmission, and the specific implementation may vary based on system requirements.

In some aspects, an in-band signaling mechanism within the data stream may communicate training completion status. The in-band signaling mechanism embeds training completion information within the SEND_N data stream transmitted over the low data rate direction 1102, enabling the follower physical layer device to detect training completion without requiring an external signal path.

In some aspects, a sideband control channel may transmit training completion status and other operational parameters. The sideband control channel provides a dedicated communication path separate from the primary data stream for exchanging training status information and operational parameters between physical layer devices.

In some aspects, training completion may be detected implicitly by observing the change in transmitted signal format from training frame to data frame. The follower physical layer device monitors the signal received on the low data rate direction 1102 and detects the transition from SEND_T to SEND_N based on the change in signal format, enabling implicit detection of training completion without explicit signaling.

In addition to the signaling mechanisms described above, the continuous signal transmission during link synchronization enables the receiving side to recover the clock from the transmitted signal. In crystal-less configurations where clock offset may be substantial, the continuous signaling from the start of link synchronization allows training functions to be performed during a link synchronization phase. The extended continuous sequence of unaltered bits within the training frame supports clock recovery by providing a consistent pattern for timing acquisition. In some aspects, a controller at a receiving physical layer device may extract timing information from the continuous sequence of unaltered bits to facilitate timing recovery.

In some aspects, frame error rate monitoring and block error detection may be implemented for enhanced link quality assessment during training. The frame error rate monitoring tracks the rate of frame errors detected during the training sequence, and the block error detection identifies errors within individual encoded blocks. The link quality assessment enables physical layer devices to evaluate channel conditions and adjust training parameters accordingly.

In some aspects, extended status bit signaling beyond loc_rcvr_status, en_slave_tx, and timing_lock_OK may be implemented for additional link state information. The extended status bit signaling provides additional status bits within the information field of the training frame to communicate supplemental link state information between physical layer devices during training.

Beyond the status bit signaling described above, in some aspects, a closed-loop acknowledgment mechanism may be implemented for link synchronization signal reception confirmation. The closed-loop acknowledgment mechanism enables a physical layer device to confirm receipt of a link synchronization signal by transmitting an acknowledgment indication to the remote physical layer device. In some aspects, the leader physical layer device may notify the follower physical layer device of receipt of the link synchronization signal by changing a bit in the information field. The acknowledgment indication may comprise a bit transition in an information field that confirms successful receipt of the synchronization signal, addressing synchronization failures that could otherwise occur when channel noise corrupts acknowledgments in open-loop approaches. This closed-loop feedback capability addresses limitations in prior approaches that relied on open-loop feedback for link synchronization.

In accordance with the foregoing disclosure, the disclosed techniques provide benefits in comparison to conventional training approaches for asymmetric communication links. Embodiments of the present disclosure provide methods and apparatuses for training asymmetric communication links that connect devices such as cameras and sensors to processing units. In these asymmetric links, data flows faster in one direction than the other to accommodate varying bandwidth requirements.

A first physical layer device transmits a training frame on a low data rate direction of an asymmetric communication link. The training frame groups altered bits together at one or more frame boundaries, positioning the altered bits to maximize the length of a continuous sequence formed by unaltered bits. The unaltered bits form a continuous sequence that extends contiguously across a remainder of the training frame. This extended continuous sequence of unaltered bits facilitates pseudo-random binary sequence locking and timing recovery by providing a longer uninterrupted pattern for receiver synchronization.

The first physical layer device receives, over the high data rate direction, a remote receiver status indication from a second physical layer device. In response to the remote receiver status indication indicating satisfactory receiver status at the second physical layer device, the first physical layer device transitions the low data rate direction directly from a training state to a data transmission state. In some aspects, the transition occurs independent of a local receiver status of the first physical layer device. This enables the low data rate direction to complete training and begin data transmission prior to the high data rate direction completing its training sequence.

In some aspects, an apparatus comprises a receiver configured to receive, from a remote physical layer device, a training frame on a low data rate direction of an asymmetric communication link, and a transmitter configured to transmit, over a high data rate direction, a remote receiver status indication to the remote physical layer device. The apparatus may further comprise a controller configured to extract timing information from a continuous sequence of unaltered bits within the training frame to facilitate timing recovery.

In some aspects, the low data rate direction employs a common modulation for training and data transmission, enabling the omission of a countdown state from a state machine controlling transmissions on the low data rate direction. This reduces the number of states in the state machine, simplifying control logic while maintaining full functionality. The training frame may comprise a modified information field that eliminates fields rendered not utilized by the omission of the countdown state while retaining a start of frame delimiter that identifies the training frame. In applications such as automotive camera links, this enables camera sensor initialization to proceed while the high data rate direction continues training, reducing camera link readiness time.

In the foregoing Detailed Description, the following terminology and conventions have been used: The term “configured to” describes hardware, software, firmware, or combinations thereof arranged, programmed, or provisioned to perform a stated function, referring to capability resulting from structure and/or programming rather than mere intended use. The term “coupled” indicates direct or indirect interaction, association, or communication (for example, electrical, logical, data, or signal coupling), with or without intervening elements. Wired and wireless connections are included unless the specification specifies otherwise. The terms “about” or “approximately” indicate a value within normal engineering, measurement, or numerical tolerance for the context. Unless otherwise specified, “about” may encompass plus or minus 10% of the stated value or a tolerance appropriate to the resolution or precision stated. Numeric ranges are inclusive of endpoints and include all subranges and intermediate values. Where a range is recited with “about,” the approximation applies to endpoints and intermediate values unless otherwise indicated. Terms such as “optional,” “optionally,” and “may” indicate that a feature, step, or parameter can be present or absent, enabled or disabled, without implying that alternatives are excluded. Optional features can be used individually or in any combination.

Reference numerals and figure conventions have been applied as follows: The same reference numeral refers to the same or functionally equivalent element across figures. Suffixes (such as 406a, 406b) or primes may denote variants, instances, or related elements. Drawings are schematic and not to scale unless the specification expressly indicates otherwise. Relative sizes and spatial relationships may be exaggerated for clarity. Block diagrams depict functionality and/or logical groupings; a single block may represent multiple components or functions, and multiple blocks may be implemented within a single component. Flowchart steps may be performed in different orders, in parallel, iteratively, and/or with steps added or omitted, unless a particular order is expressly specified.

Units and coordinate systems have been used as follows: International System of Units (Système International d'Unités, SI) units are used unless stated otherwise. Frequencies are in hertz (Hz); time is expressed in seconds(s) or derived units; data rates may be expressed in bits per second or baud. Signal timing diagrams are illustrative and not to scale; references to “leader/follower,” “leader/slave,” “upstream/downstream,” or “transmit/receive” indicate signal flow directionality, not physical orientation.

Cross-references to figures have been provided for illustrative context (for example, “FIG. 1”). Figure numbers do not imply priority, sequence, or exclusivity. Components shown in different figures can be combined or substituted as technically appropriate.

These conventions apply throughout the Detailed Description to all elements, components, features, and configurations described herein, and to their variants and equivalents.

The foregoing description has set forth exemplary aspects of the present disclosure. Such description does not limit the scope of the present disclosure; rather, the description encompasses combinations and modifications to those exemplary aspects described herein. Various modifications may be made without departing from the spirit and scope of the disclosure. Accordingly, other implementations are within the scope of the following claims.

What is claimed is:

1. A method comprising:
transmitting, by a first physical layer device, a training frame on a low data rate direction of an asymmetric communication link, the asymmetric communication link further comprising a high data rate direction, the training frame comprising altered bits grouped together at one or more frame boundaries, the altered bits being positioned to maximize a length of a continuous sequence formed by unaltered bits, and the unaltered bits forming the continuous sequence that extends contiguously across a remainder of the training frame;
receiving, by the first physical layer device and over the high data rate direction, a remote receiver status indication from a second physical layer device; and
transitioning, by the first physical layer device, the low data rate direction directly from a training state to a data transmission state in response to the remote receiver status indication indicating satisfactory receiver status at the second physical layer device.

2. The method of claim 1, wherein the transitioning is independent of a local receiver status of the first physical layer device, and wherein a state machine controlling transmissions on the low data rate direction omits a countdown state.

3. The method of claim 2, wherein the low data rate direction employs a common modulation for training and data transmission, and wherein the state machine omits the countdown state based on the common modulation being employed for training and data transmission in the low data rate direction.

4. The method of claim 3, wherein omitting the countdown state enables the low data rate direction to transition to the data transmission state prior to the high data rate direction transitioning to the data transmission state, and wherein the first physical layer device transmits data frames on the low data rate direction while the second physical layer device continues to transmit training frames over the high data rate direction to enable the first physical layer device to complete training on the high data rate direction.

5. The method of claim 4, further comprising transmitting configuration data over the low data rate direction while the high data rate direction continues training.

6. The method of claim 3, wherein the training frame comprises a modified information field that eliminates a partial frame count field rendered not utilized by omission of the countdown state, the modified information field retaining a start of frame delimiter that identifies the training frame.

7. The method of claim 1, wherein the unaltered bits comprise zero-filled encoded blocks.

8. The method of claim 7, wherein the zero-filled encoded blocks are produced by operating an encoder of the first physical layer device in a fault mode while a data mode indicator of the first physical layer device is deasserted.

9. The method of claim 7, wherein the training frame comprises a distinguishing characteristic that differentiates the training frame from data frames, the distinguishing characteristic enabling the second physical layer device to distinguish between training frames containing the zero-filled encoded blocks and data frames containing encoded blocks with all-zero payload data.

10. The method of claim 1, wherein the high data rate direction employs a first modulation for training and a second modulation different from the first modulation for data transmission.

11. The method of claim 1, wherein the training frame comprises a forward error correction frame structure with an information field positioned at a first frame boundary, forward error correction parity bits positioned at a second frame boundary, and the continuous sequence of unaltered bits positioned between the information field and the forward error correction parity bits.

12. The method of claim 1, wherein the remote receiver status indication is communicated via one or more status bits within an information field of a training frame transmitted by the second physical layer device over the high data rate direction.

13. The method of claim 1, wherein the training frame serves as a substitute for a separate synchronization signal during link synchronization, wherein the continuous sequence of unaltered bits comprises a prolonged series of zeros, and wherein the prolonged series of zeros enables combined link synchronization and training using a common signal framing for both link synchronization and training operations.

14. The method of claim 1, further comprising receiving, by the first physical layer device, a link synchronization signal from the second physical layer device, and transmitting, by the first physical layer device, an acknowledgment indication to the second physical layer device by changing a bit in an information field of the training frame, the acknowledgment indication confirming receipt of the link synchronization signal.

15. An apparatus comprising:
a first physical layer device, the first physical layer device comprising:
a transmitter configured to transmit a training frame on a low data rate direction of an asymmetric communication link, the asymmetric communication link further having a high data rate direction;
a receiver configured to receive, over the high data rate direction, a remote receiver status indication from a second physical layer device; and
a controller configured to transition, via a state machine that omits a countdown state, the low data rate direction directly from a training state to a data transmission state in response to the remote receiver status indication indicating satisfactory receiver status at the second physical layer device, wherein the transitioning occurs without requiring a local receiver status of the first physical layer device to indicate satisfactory operation.

16. The apparatus of claim 15, wherein the transmitter comprises a modulator configured to apply a common modulation scheme for both training frame transmission and data frame transmission on the low data rate direction, and wherein the state machine omits the countdown state based on the modulator applying the common modulation scheme for both training frame transmission and data frame transmission.

17. The apparatus of claim 15, wherein the transmitter comprises a frame generator configured to produce the training frame with altered bits grouped together at one or more frame boundaries, the frame generator positioning the altered bits to maximize a length of a continuous sequence of unaltered bits, and the frame generator producing unaltered bits that form a continuous sequence extending contiguously across a remainder of the training frame.

18. The apparatus of claim 17, wherein the unaltered bits comprise zero-filled encoded blocks.

19. An apparatus comprising:
a receiver configured to receive, from a remote physical layer device, a training frame on a low data rate direction of an asymmetric communication link, the asymmetric communication link further having a high data rate direction; and
a transmitter configured to transmit, over the high data rate direction, a remote receiver status indication to the remote physical layer device, the remote receiver status indication enabling the remote physical layer device to transition, via a state machine that omits a countdown state, the low data rate direction directly from a training state to a data transmission state in response to the remote receiver status indication indicating satisfactory receiver status, wherein the transitioning occurs without requiring a local receiver status of the remote physical layer device to indicate satisfactory operation.

20. The apparatus of claim 19, wherein the training frame comprises unaltered bits forming a continuous sequence, and further comprising a controller configured to extract timing information from the continuous sequence of unaltered bits within the training frame, the continuous sequence of unaltered bits extending contiguously across a portion of the training frame to facilitate timing recovery.
